(19) United States
(12) Patent Application Publication
(10) Pub. No.: US 2018/0357589 A1
(43) Pub. Date: Dec. 13, 2018

(54) SYSTEMS AND METHODS FOR DETERMINING GEOGRAPHICAL SERVICE AREAS WITH BALANCED WORKLOAD

(71) Applicant: MOTOROLA SOLUTIONS, INC., Chicago, IL (US)

(72) Inventors: Mariya Bondareva, Bolingbrook, IL (US); Randy K, Ekl, Lake Zurich, IL (US)

(21) Appl. No.: 15/617,996

(22) Filed: Jun. 8, 2017

(51) Int. Cl. G06Q 10/06

(52) U.S. Cl. CPC G06Q 10/063114; G06Q 50/26

(57) ABSTRACT

A method of determining geographic service areas. The method includes receiving, at an electronic processor, map information corresponding to a geographical area, and receiving, at the electronic processor, incident information corresponding to the geographical area. The method also includes generating, with the electronic processor, a plurality of partition maps of the geographical area based on the map information and the incident information, and displaying the plurality of partition maps as symbols on a chart according to a compactness index and a workload distribution index of each partition map. Each partition map includes one or more partitions, and each partition represents a geographical service area.

### BACKGROUND OF THE INVENTION

Public service agencies typically operate within a geographical area (for example, a district, city, county, or similar jurisdictional boundary). The geographical area is partitioned into multiple non-overlapping geographical service areas. A particular set of geographical service areas that divide the geographical area may be referred to as a partition map. Workers are then assigned to a particular geographical service area within which they respond to service calls. Service calls could relate to services provided by police, fire, sanitation, and other public and private service agencies.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a geographical service area determination system in accordance with some embodiments.

FIG. 2 is a flowchart illustrating a method of determining geographical service areas according to some embodiments.

FIG. 3 illustrates an example partition map.

FIG. 4 illustrates an example chart for displaying symbols representing different partition maps generated by the system of FIG. 1.

FIG. 5 is a flowchart illustrating a method of generating a plurality of partition maps.

FIGS. 6A-6C illustrate a geographical area divided into regions based on different values of a region size input parameter.

FIGS. 7A-B illustrate connections in an adjacency graph based on different values for a graph linkage input parameter.

FIGS. 8A-8C illustrate different adjacency graphs generated based on different input parameters.

FIG. 9 illustrates two clusters with different compactness indices.

FIG. 10 illustrates a table comparing two partition maps based on a workload distribution index.

FIG. 11 illustrates a pop-up window including details regarding a partition map.

FIGS. 12A-B illustrate example charts for displaying symbols representing different partition maps focusing on different incident types.

FIG. 13 illustrates two tables comparing two different partition maps.

FIG. 14 is a flowchart illustrating a method of determining a similarity value for a partition map.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Determining precisely how to divide a geographical area into different service areas is challenging due to the number of different possible combinations of geographical service areas, the number of parameters that affect the determination of the geographical service areas, and the workload associated with each geographical service area.

Additionally, even if several different combinations of the geographical service areas are generated, it is difficult to determine which combinations are better than others. Rather, managers and other individuals at service agencies (sometimes referred to as users herein) rely on previous experience to determine, subjectively, an appropriate combination of the geographical service areas for a given geographical area (for example, a city, district, county, or the like). It may not be apparent that an inadequate partition map was selected until, for example, certain partitions (that is, geographical service areas) consistently show a significantly higher or lower workload than the rest of the partitions (that is, the workload among partitions is unbalanced). Even when it is determined that a partition map was selected erroneously, no further insight is gained as to which map would be better, except that the appropriate partition map was not the previously selected one.

One embodiment provides a method of determining geographic service areas. The method includes receiving, at an electronic processor, map information corresponding to a geographical area, and receiving, at the electronic processor, incident information corresponding to the geographical area. The method also includes generating, with the electronic processor, a plurality of partition maps of the geographical area based on the map information and the incident information, and displaying the plurality of partition maps as symbols on a chart according to a compactness index and a workload distribution index of each partition map. Each partition map includes one or more partitions, and each partition represents a geographical service area.

Another embodiment provides a service area determination system including a memory, an electronic processor coupled to the memory, and a display screen coupled to the electronic processor. The electronic process is configured to extract instructions from the memory, and execute the instructions to receive map information corresponding to a geographical area, and receive incident information corresponding to the geographical area. The electronic processor also executes the instructions to generate a partition map of the geographical area based on the map information and the incident information. The partition map includes one or more partitions, and each partition represents a geographical service area. The display screen is configured to display the partition map as a symbol on a chart according to a compactness index and a workload distribution index of the partition map.

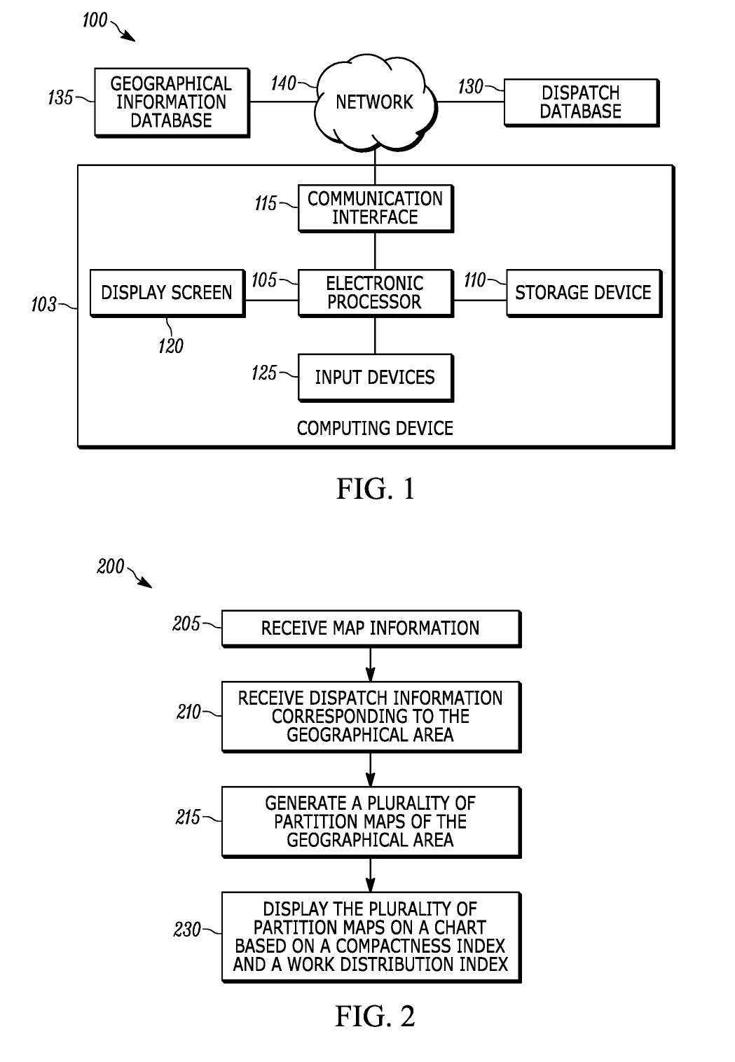

FIG. 1 is a block diagram of an example geographical service area determination system 100. The system 100 of FIG. 1 generates and displays different partition maps corresponding to a given geographical area (for example, a particular city, district, county or other jurisdictional boundary) for a specific public service agency. The public service agency may include, for example, a police department, a fire department, an emergency medical services department, and the like. In the example shown in FIG. 1, the system 100 includes a computing device 103 including an electronic processor 105, a storage device 110, a communication interface 115, a display screen 120, and input devices 125. The computing device 103 may be, for example, a laptop computer, a desktop computer, a tablet computer, a smartphone, or other similar computing device. The computing device 103 accesses an incident database 130 and a geographical information database 135 via the communication interface 115. The communication interface 115 accesses the incident database 130 and the geographical information database 135 over a communication network 140. The system 100 may include more or less components than those explicitly described herein.

The communication network 140 may be a wired network or a wireless network and may be implemented using a wide area network, such as the Internet, a local area network, such as Wi-Fi, or combinations or derivatives thereof. It should be understood that the computing device 103 and the databases 130, 135 may communicate over more than one communication network and different pairs of components may communicate over different networks. Also, in some embodiments, the computing device 103 may communicate with the databases 130, 135 over a dedicated connection rather than a communication network.

In the example shown in FIG. 1, the computing device 103 includes the electronic processor 105 (for example, a microprocessor, application-specific integrated circuit (ASIC), or another suitable electronic device), the storage device 110 (for example, a non-transitory, computer-readable storage medium), the communication interface 115, such as a transceiver for communicating over the communication network 140, other communication networks, or a combination thereof.

As illustrated in FIG. 1, the computing device 103 also includes input devices 125 and a display screen 120. The input devices 125 receive input from a user of the computing device 103. The input devices 125 may include, for example, a keyboard, a pointer device, a touchscreen, a touchpad, and the like. Analogously, the display screen 120 provides an output to the user of the computing device 103. In some embodiments, the display screen 120 may also be a touchscreen and can thus operate as both an input device 125 and an output device. In some embodiments, the computing device 103 may include additional output devices such as, for example, a speaker, a vibration motor, and the like. It should be understood that the computing device 103 may include additional components than those illustrated in FIG. 1 in various configurations and may perform additional functionality than the functionality described in the present application.

The electronic processor 105, the storage device 110, the communication interface 115, the input device 125, and the display screen 120 communicate over one or more wired communication lines or buses or wirelessly. The storage device 110 stores software (instructions). For example, the storage device 110 stores instructions to be extracted and executed by the electronic processor 105 to determine (for example, generate) geographical service areas for the public service agency.

Through the communication interface 115, the computing device 103 communicates with the geographical database 135 via the communication network 140 to receive geographical boundaries and other geographical data for a specific public service agency. The computing device 103 may receive, for example, the geographical boundaries that indicate the limits of jurisdiction for a public service agency (for example, a police district boundary). The geographical boundaries include, for example, latitudinal and longitudinal coordinates that indicate the boundary for the specific public service agency. In some embodiments, the geographical information database 135 also stores other map landmarks such as roads, lakes, rivers, bridges, and the like. In some embodiments, the geographical information database 135 stores the geographical boundaries for several different public service agencies. For example, the geographical information database 135 may store the jurisdictional boundaries for several police districts. In another example, instead of accessing a geographical information database 135 as shown in FIG. 1, the electronic processor 105 receives a geographical data file including the geographical data regarding the particular public service agency. For example, the data file may specify the latitudinal and longitudinal coordinates for the boundary for a public service agency as well as other map landmarks such as roads, lakes, rivers, bridges, mountains, and the like.

The computing device 103 also communicates with the incident database 130 over the communication network 140 using the communication interface 115 to receive incident data associated with a particular public service agency. In particular, the incident database 130 stores information regarding calls for service received and/or handled by the public service agency. In other words, the incident information includes information regarding calls for service received, but not attended to (for example, because the service agency attended to a different call for service), as well as dispatch information for the calls for service, which the service agency attended. In some cases, the information regarding calls for service received, but not addressed may be referred to as an expected workload demand, while the dispatch information may be referred to as an actual workload demand. In the illustrated embodiment, the incident information from the incident database 130 also corresponds to the geographical area of the public service agency. For example, when the public service agency includes a police department, the incident information stored in the incident database 130 corresponds to the geographical area assigned to the police department. In some embodiments, the incident database 130 stores information for multiple public service agencies, for example, multiple police departments. In such embodiments, the incident information is associated with geographical information such that the incident data may be sorted by the geographical area (for example, the originating location of a service call) for a specific public service agency. The incident database 130 may be maintained remotely from the computing device 103, or, in some embodiments, may be maintained by the computing device 103. In one example, the incident database 130 stores incident information that includes unattended incident data and/or dispatch data for a public service agency (such as, for example, a police department). In such an example, the unattended incident data includes type of incident, a location of the incident, an expected time to resolve the incident for the calls for service received by the public service agency but not addressed by the public service agency. The dispatch data includes, for example, a type of incident, a location of the incident, an identification code for a worker who responded to the incident, a time allocated to the incident, and the like.

FIG. 2 is a flowchart illustrating a method 200 of determining geographic service areas for a public service agency. In the example shown in FIG. 2, the method 200 includes receiving map information corresponding to a geographical area at the electronic processor 105 (block 205). As described above, the electronic processor 105 receives the map information from the geographical information database 135. The map information for the geographical area includes, for example, the geographical boundaries for the jurisdiction of the public service agency. For example, the map information may include the geographical boundaries for a police department. In some embodiments, the electronic processor 105 receives the map information through a data file accessed from the storage device 110 rather than from the geographical information database 135. The electronic processor 105 also receives incident information corresponding to the geographical area (block 210). As described above, the communication interface 115 accesses the incident database 130 to receive incident information corresponding to the geographical area for the public service agency (for example, a police department).

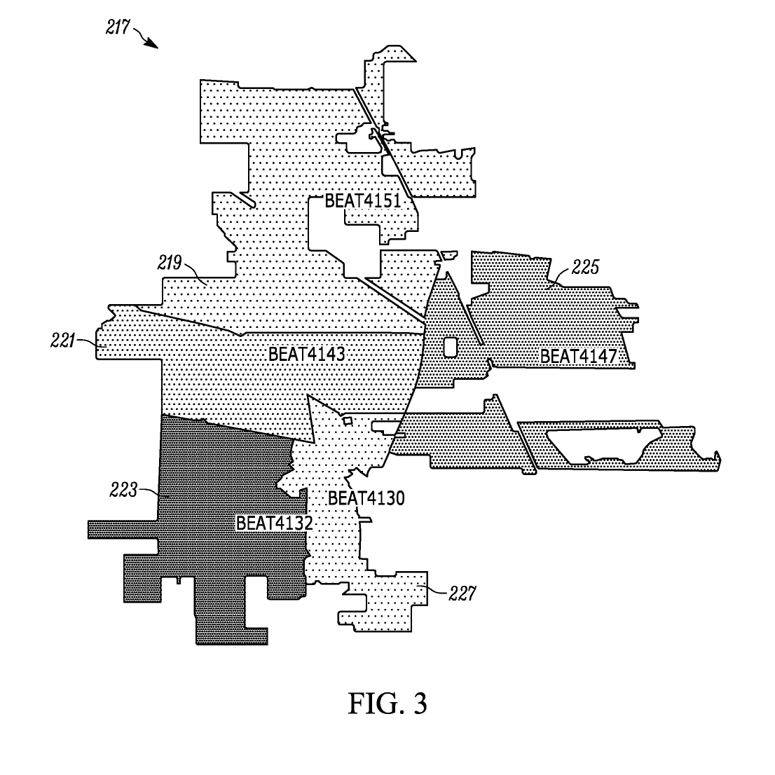

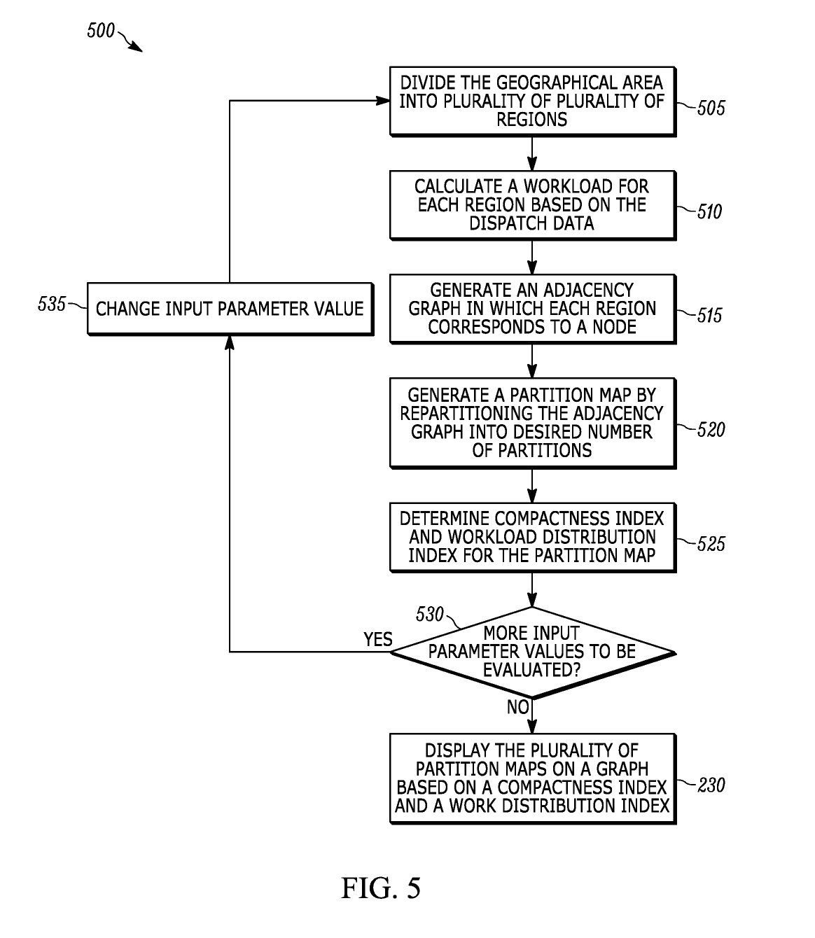

After receiving the map information and the incident information corresponding to the geographical area, the electronic processor 105 generates a plurality of partition maps of the geographical area based on the map information and the incident information (block 215). FIG. 3 illustrates an example partition map 217. Each partition map 217 corresponds to the geographical area for the public service agency, and includes a plurality of partitions 219-227. Each of the partitions 219-227 corresponds to a geographical service area. The geographical service area may be referred to by some public service agencies as a beat (for example, a police beat). Workers from the public service agency are then divided among the different geographical service areas. For example, two police officers may be assigned to each geographical service area. Because the workforce of the public service agency is divided among the geographical service areas, it is important for the workload to be balanced among the geographical service areas. The electronic processor 105 utilizes the incident information in generating the plurality of partition maps 217 to determine how the workload is balanced in each partition map, as described in more detail with reference to FIG. 5.

The electronic processor 105 then utilizes the display screen 120 to display the plurality of partition maps as symbols on a chart according to a compactness index and a workload distribution index of each partition map (block 230). The compactness index provides a measure of the relative compactness of each partition within the particular partition map, while the workload distribution index provides a measure of the workload balance achieved by dividing the partition map into the different partitions. The compactness index decreases as the partitions within a partition map are more compact. Analogously, the workload distribution index also decreases as the workload among the different partitions is more balanced.

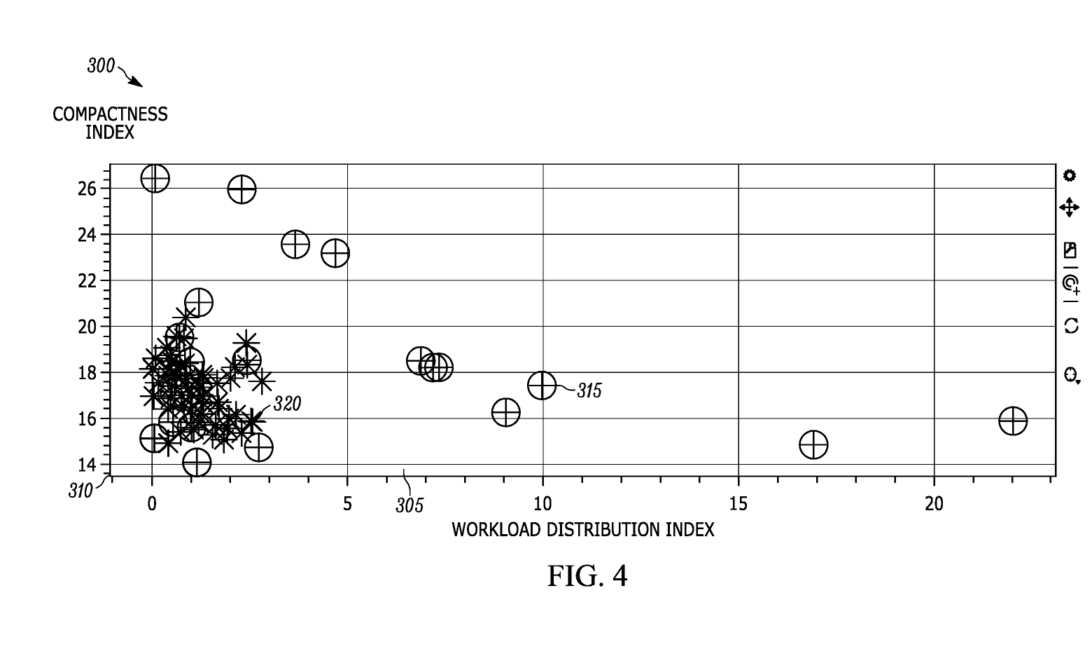

FIG. 4 illustrates an example of the chart 300 generated by the electronic processor 105. In the example shown in FIG. 4, the chart 300 includes a first axis 305 corresponding to the workload distribution index and a second axis 310 corresponding to the compactness index. A plurality of different symbols 315, 320 are positioned within the chart 300. Each of the symbols 315, 320 corresponds to a particular partition map generated by the electronic processor 105. The position of each symbol 315, 320 on the chart 300 provides a visual indication of the quality of the partition map. The quality of the partition map refers to how well the partition map is expected to perform if implemented for the geographical area. In the illustrated embodiment, the symbols positioned near the edges of the chart 300 correspond to the partition maps with lower compactness indices and lower workload distribution indices. Because the workload distribution index and the compactness index decrease as the workload is more balanced and the partitions are more compact, respectively, the partition maps represented by the symbols closest to the axes are expected to perform better when implemented over the geographical area associated with the public service agency.

Generating such a display allows users to intuitively identify the partition maps with better compactness indices and better workload distribution indices, indicating which partition maps are expected to perform better when implemented by the public service agency. Without calculating the compactness index and the workload distribution index for each partition map, users are trapped visually inspecting each partition map without any particular measures indicating which partition maps may perform better when implemented. Additionally, generating the chart displaying the symbols representing the different partition maps allows the user to more easily identify the better partition maps option without searching through cumbersome tables.

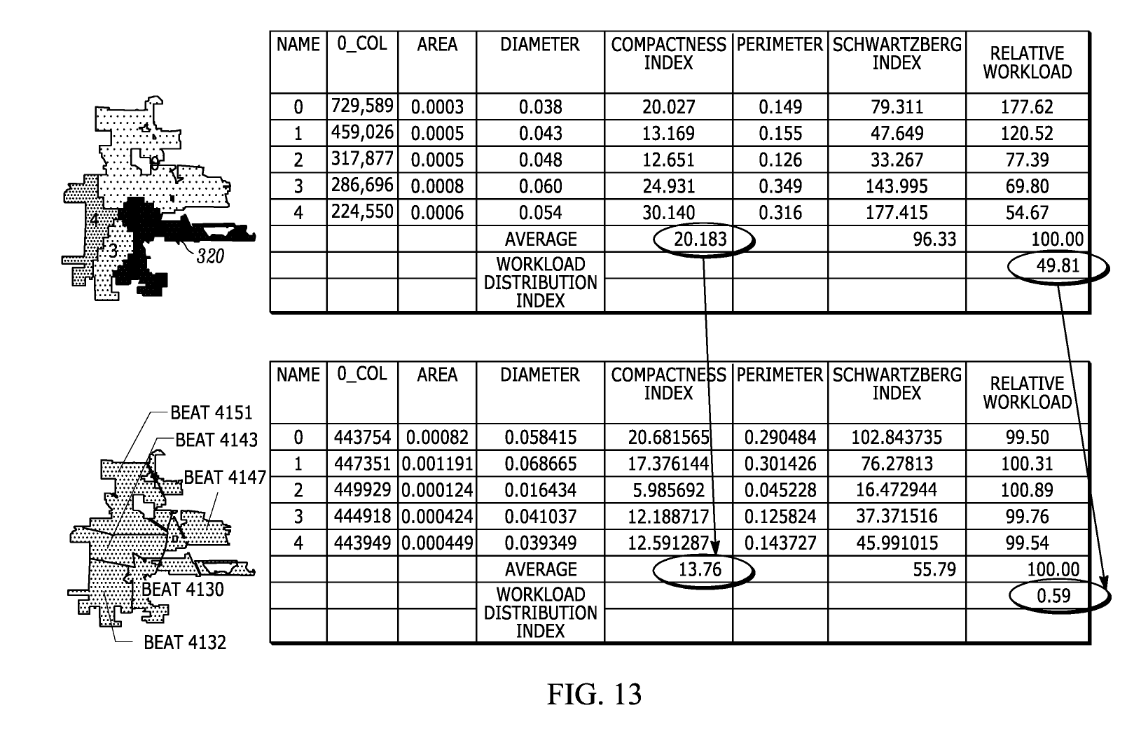

Typically, determining how to divide a geographical area assigned or associated with a public service agency (for example, a police department) requires long hours and a significant amount of previous experience to select the appropriate division of the geographical area into partitions corresponding to geographical service areas. Typical software used to generate different partition maps uses a variety of input parameters. Slight changes to the input parameters, however, generate significantly different partition maps. Therefore, if the input parameters are varied, a large number of potential partition maps are generated. However, comparing two different partition maps and predicting how well each partition map may perform while implemented has been left to the subjective opinion of those users with sufficient experience. That is, an experienced police officer or sergeant may visually inspect each of the partition maps and determine, based on his/her experience policing the associated geographical area which partition maps may perform better than others. The experienced individual may look, for example, for elongated partitions (see, for example, 320 on FIG. 13) and avoid the partition maps that display these. These elongated partitions are considered difficult to service (for example, patrol) because the amount of time that it takes to travel from one end of the elongated partition to the other is longer than, for example, an acceptable response time.

The experienced individual may also determine, based on his/her own previous experience in the geographical area, approximately how the workload may be balanced in different partition maps, but assessing the workload balance of the partitions may also be a subjective process in some cases. While it may be obvious which partition maps have the worst workload balance, selecting among the partition maps that have more similar workload balance is significantly more difficult to perform subjectively. The users assigned to determine the geographical service areas (that is, the partitions) for the geographical area for the public service agency, therefore, may have no objective measures that indicate how to select a partition map that is expected to perform well when implemented. In some cases, measurements like an average workload balance and a standard deviation are used to help determine which partition map to select, but as discussed in further detail with respect to FIG. 10, these measurements are often conflicting. Generating a graphical display like the one shown in FIG. 3 solves the aforementioned issues, as well as others, and allows the users to select a partition map based on objective measures that are expected to correspond to the success of implementation of each partition map, instead of relying solely of subjective opinions and previous experience. After selecting a partition map, the computing device 103 may, in some embodiments, transmit the partition map to another computing device and/or a plurality of electronic devices (e.g. portable communication devices). For example, in some embodiments, the computing device 103 transmits the selected partition map to the portable communication devices assigned to the members of the public service agency via the network 140 or via a different wired or wireless network. The portable communication devices receive the selected map and are thereby informed of the different geographical service areas.

As discussed above, the partition maps generated by the electronic processor 105 are based on the incident information and the map information. The partition maps are also based on the values assigned to various input parameters. In some embodiments, the electronic processor 105 receives an indication of the desired value for some or all of the input parameters. In other embodiments, the electronic processor 105 selects a value for some or all of the input parameters. In the illustrated embodiment, however, the electronic processor 105 generates various sets of partition maps by changing the values of the input parameters. The input parameters include, for example, a desired number of geographical service areas (that is, beats), a region size, buffer distance, edge connectivity, edge weight, desired workload distribution, and workload imbalance threshold.

The desired number of geographical service areas is specified by a user based on, for example, the typical number of workers during a shift, or other aspects of the public service agency. The electronic processor 105 receives an indication via the input device 125 of the desired number of geographical service areas (that is, the number of partitions) for the geographical area. In some embodiments, the user may indicate a range of desired number of geographical service areas such as, for example, four to six geographical areas. The electronic processor 105 will then generate different partition maps including four, five, or six geographical service areas. The desired workload distribution and the workload imbalance threshold are also received by the electronic processor 105 from the user via the input device 125. The desired workload distribution (for example, a target workload for each geographical service area) indicates the percentage of total workload that is to be allocated to each of the geographical service areas (or partitions). While in some embodiments, the desired workload distribution is uniform (that is, each partition within a partition map should have approximately equal workload), in other embodiments, each partition may have varying workloads and the workforce of the public service agency is allocated accordingly. In one example, a geographical area is divided into three geographical service areas, and the workload distribution indicates that a first partition should handle 20% of the workload, the second partition should handle 30% of the workload, and the third partition should handle 50% of the workload. In other embodiments, the specific percentages associated with each partition may vary. The workload imbalance threshold indicates the allowed disparity between the desired workload distribution and the actual workload distribution of the partition. For example, in embodiments in which the workload distribution is equal, the workload imbalance threshold may be set to about 10%. For example, if the geographical area is divided into five geographical service areas (that is, beats) and a uniform workload distribution is desired, then the maximum workload in any geographical service area is not to exceed 22% (that is 20% plus 10% of the 20% (2%)) or be lower than 18% (20% minus 10% of the 20% (2%)). The workload imbalance is not set greater than 100% or lower than 0%. In other examples, the workload imbalance threshold may be set to 5%, 15%, 20%, among others.

The buffer distance parameter refers to a deviation distance from the geographical boundaries indicated from the map information for the specific public service agency. In other words, the buffer distance includes a distance extending from a perimeter of the geographical boundary for the geographical area. The buffer distance accounts for any time that may be allocated to responding to service calls that are just outside the geographical boundaries for the specific public service agency. For example, a police department may answer to service calls that are a city block from its official geographical boundaries. The buffer distance may be set, for example, to 10 meters, 25 meters, 50 meters, and the like. Including this additional area into the calculations allows the electronic processor 105 to create more alternative partition maps that may have lower compactness indices and/or lower workload distribution indices. Additionally, including the buffer distance allows the geographical service area generation system 100 to account for a workload experienced by workers of the public service agency when responding to calls for service (that is, to account for a real workload).

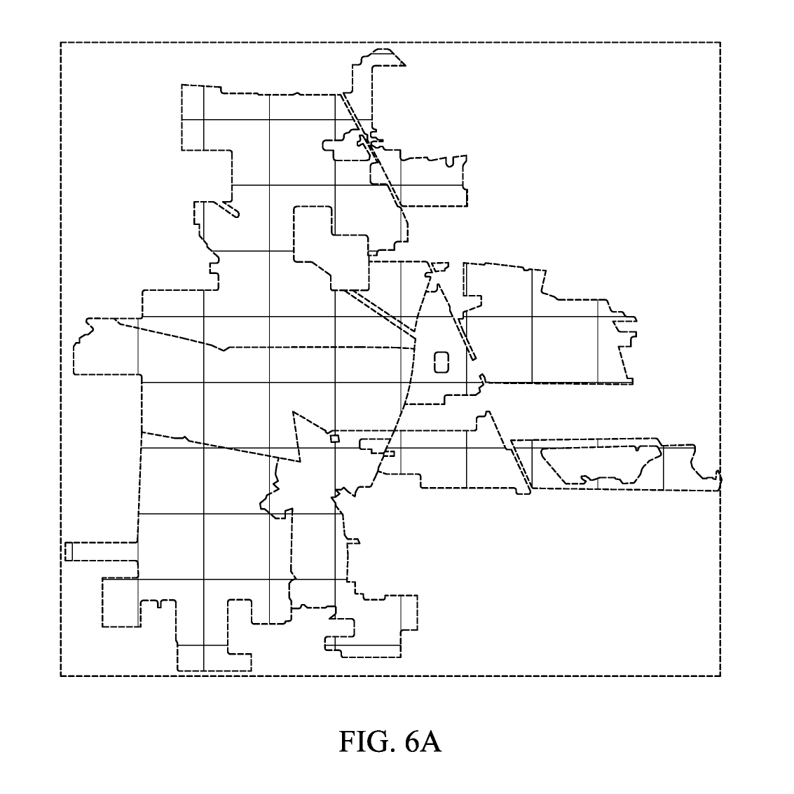

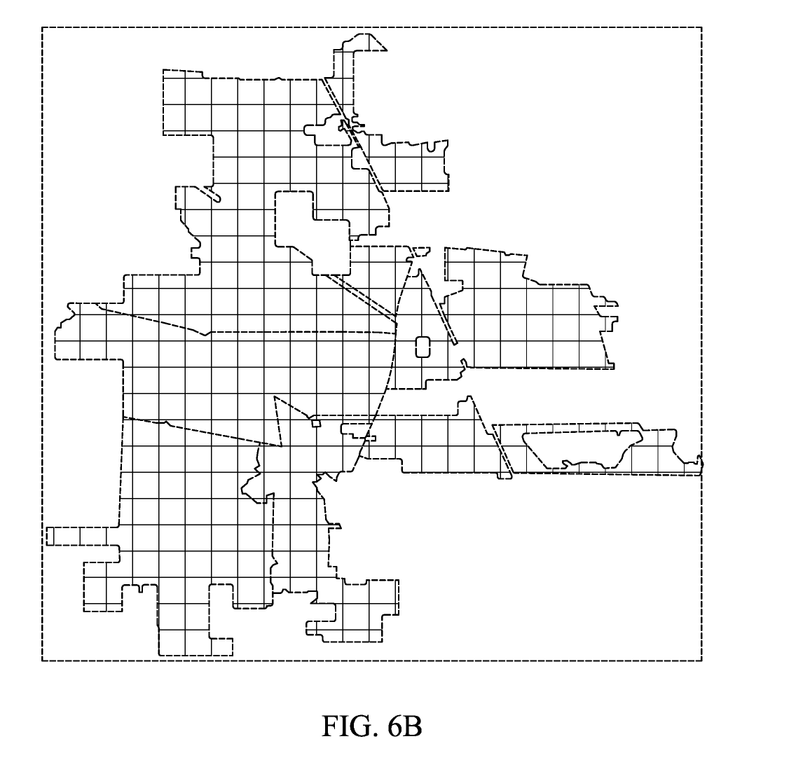

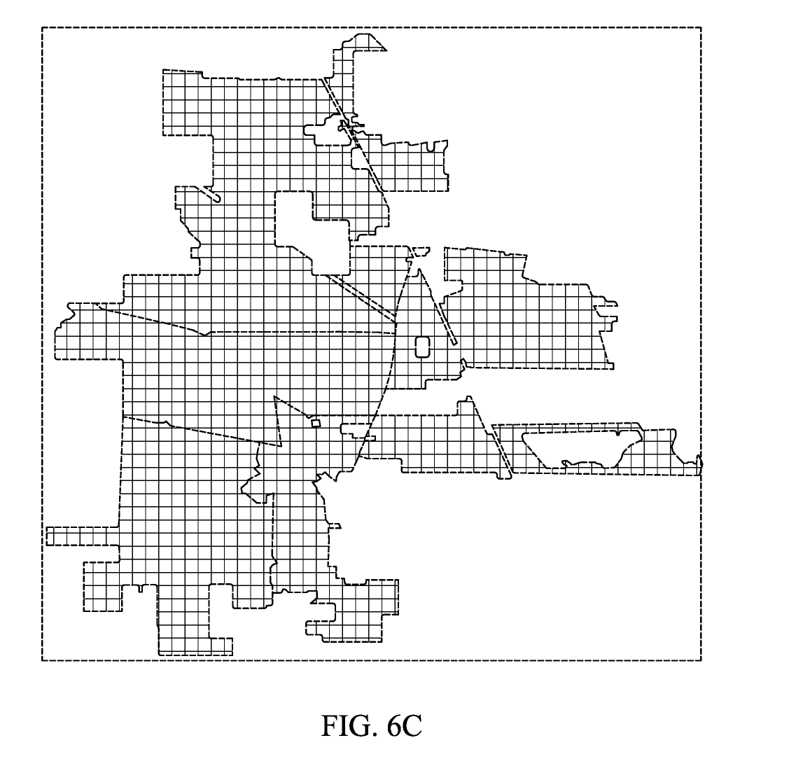

FIG. 5 is a flowchart illustrating a method 500 of generating the plurality of partition maps as discussed above with respect to block 215. In the example embodied in method 500, the electronic processor 105 divides the geographical area (that is, the geographical area associated with the public service agency) into a plurality of regions (block 505). FIGS. 6A-6C illustrate an example geographical area divided into a plurality of regions. In the examples shown in FIGS. 6A-6C, a grid of equally sized regions is overlaid the geographical area to divide the geographical area into a grid including a plurality of regions. The value of the region size parameter determines the size of the regions of the overlaid grid. FIGS. 6A-6C illustrate the geographical area divided into the plurality of regions for different values of the region size parameter. In FIG. 6A, for example, the region size parameter has a value of approximately one kilometer. In FIG. 6B, the region size has a value of approximately 500 meters, and in FIG. 6C, the region size has a value of approximately 250 meters. The region size parameter may have a value in a geographical area, for example, squared mile, squared feet, squared meters. In other embodiments, however, the region size parameter may have a value in a number of pixels, for example, 4 pixels that correspond to a size in an image of the map information. Although the illustrated embodiment shows the regions as squares, in some embodiments, the regions may have different shapes and may be, for example, hexagons, triangles, non-regular pentagons, or other similar shapes.

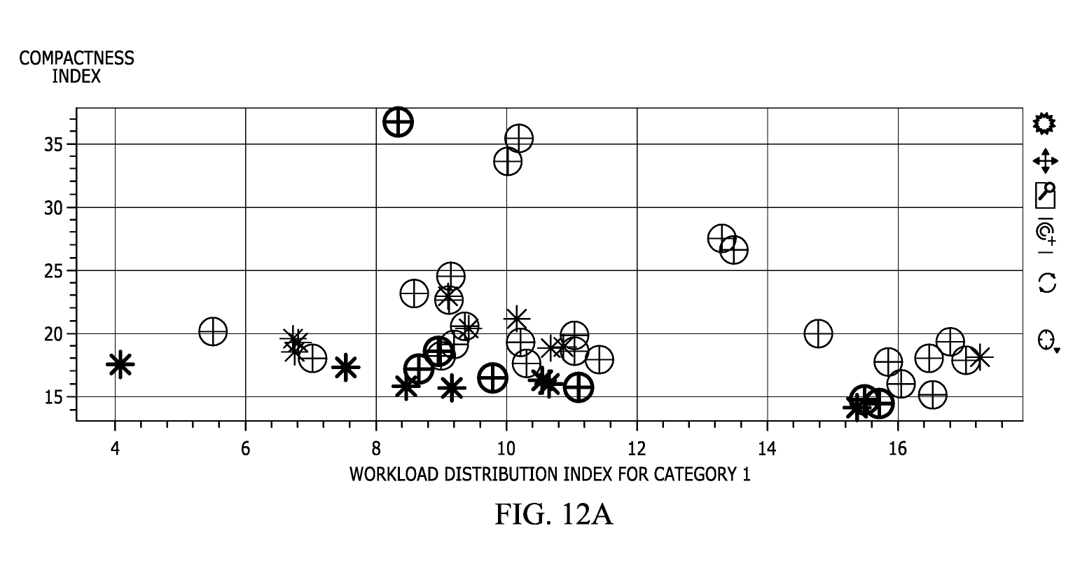

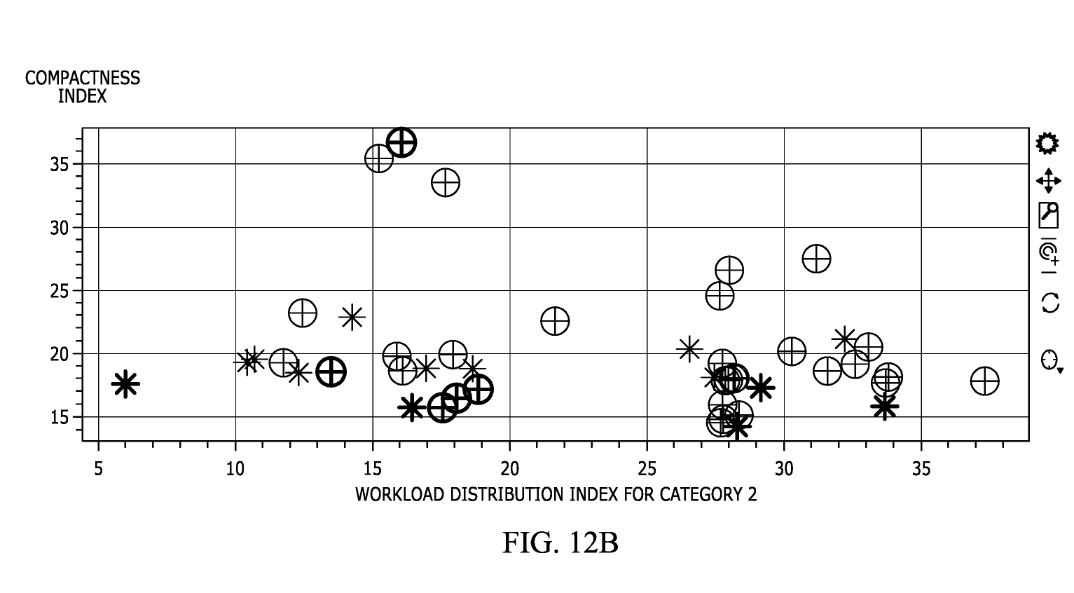

The electronic processor 105 then calculates a workload for each region based on the incident information (block 510). In the illustrated embodiment, the electronic processor 105 calculates the workload for each region based on the dispatch information to calculate the actual workload for each region. A workload vector is assigned to each region. The workload vector characterizes the time historically allocated to handle different types of incidents (or calls for service). In other words, the vector specifies the time spent on resolving incidents of a first type, incidents of a second type, incidents of a third type, and the like. The workload for each region is then calculated based on the number of service calls received for the region for a particular type of incident and for the time allocated to the incident. Because the workload vector separately indicates the time allocated to different types of incidents, the workload associated with specific types of incidents can be individually analyzed, as described below with respect to FIGS. 12A-B. In some embodiments, the electronic processor 105 alternatively or additionally calculates the workload for each region based on the unattended incident data. In such embodiments, the workload vector may specify the expected time to resolve incidents of a first type, incidents of a second type, incidents of a third type, and the like. In some embodiments, the unattended calls for service may be considered incidents of a first type, such that the workload vector for each regions specifies an expected time to resolve the unattended calls for service, and the time allocated on resolving incidents of various types (for example, of a first type, a second type, a third type, and the like).

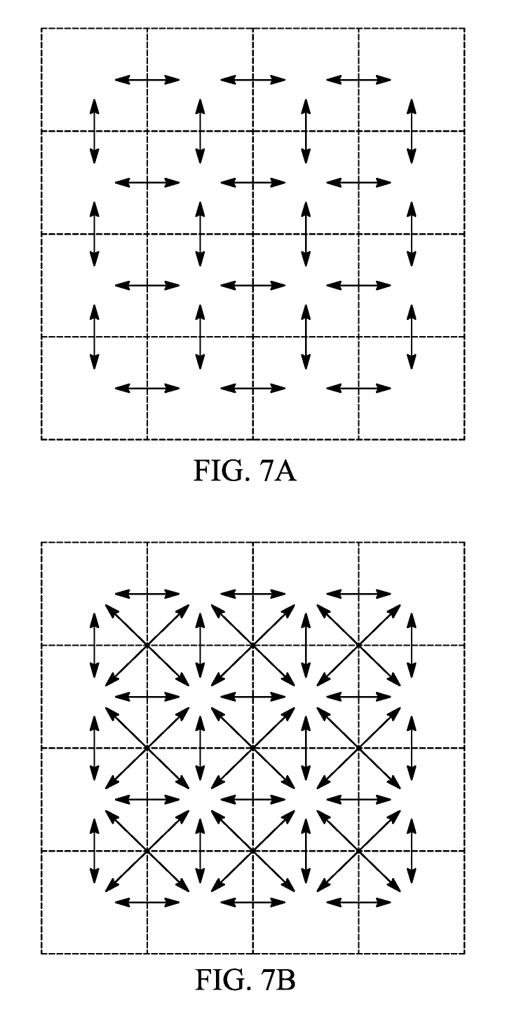

The electronic processor 105 then generates an adjacency graph in which each region is represented by a node in the adjacency graph (block 515). The electronic processor 105 generates the adjacency graph based on the edge connectivity parameter and the edge weight parameter. The edge connectivity parameter indicates how the nodes of the adjacency graph are to be connected (that is, the linkage structure of the adjacency graph). In particular, the edge connectivity parameter indicates that the nodes connect in a 4-linkage or orthogonal linkage (FIG. 7A) or in an 8-linkage, or orthogonal plus diagonal linkage (FIG. 7B). When the nodes connect in a 4-linkage manner, only nodes that are vertically and/or horizontally adjacent are connected. Therefore, each node has at most 4 connected nodes, as shown in FIG. 7A. On the other hand, when the nodes connect in an 8-linkage manner, nodes that are vertically, horizontally, and diagonally adjacent are connected. Therefore, each node in an 8-linkage connection has at most 8 connected nodes, as shown in FIG. 7B. The value of the edge connectivity parameter may be a binary indication. That is, when the edge connectivity parameter has a first value (for example, zero), the electronic processor 105 generates a 4-linkage adjacency graph, and when the edge connectivity parameter has a second value (for example, one), the electronic processor 105 creates an 8-linkage adjacency graph. In other embodiments, the edge connectivity parameter varies more than just between a 4-linkage connection and an 8-linkage connection, and the electronic processor 105 generates partition maps based on the other values for the edge connectivity parameter.

As mentioned above, the adjacency graph is also based on the edge weight parameter. The edge weight parameter is a vector with the cardinality equal to the number of edges in the adjacency graph. In the illustrated embodiment, a first weight value is assigned to all the diagonal edges, and a second weight value, which may be different than the first weight value, is assigned to all the orthogonal edges. In some embodiments, the first weight value and the second weight value may be equal. In the illustrated embodiment, the electronic processor 105 assigned higher weight values to orthogonal edges (that is, the second weight value is higher or exceeds the first weight value). Such higher weights encourage the formation of compact structures. In the illustrated embodiment, the connection in the 4-linkage adjacency graph are equally weighted (because the 4-way linkage graph includes only orthogonal edges), while the connection in the 8-linkage adjacency graph are weighted according to the edge weight parameter (since the 8-linkage adjacency graph includes both orthogonal and diagonal edges). In some embodiments, the electronic processor 105 varies the weights of orthogonal and/or diagonal (non-orthogonal) connections to generate more partition maps with potentially better workload distribution and/or compactness indices. For example, the electronic processor 105 may generate a first partition map when the diagonal edges (for example, a first diagonal edge) and the orthogonal edges (for example, a second orthogonal edge) have equal weights (that is, the first weight value and the second weight value are equal). The electronic processor 105 may then generate a second partition map when the orthogonal edge weight (that is, the second weight value) is set to 2, and the diagonal edge weight (that is, the first weight value) is set to 1. Similarly, the electronic processor 105 may also generate a third partition map when the orthogonal edge weight (that is, the second weight value) is set to 3 and the diagonal edge weight (that is, the first weight value) remains at 1.

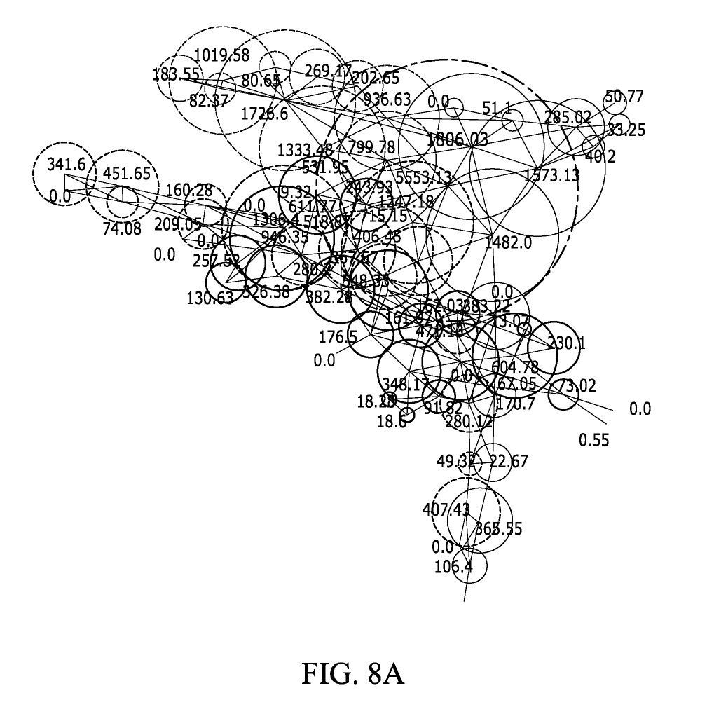

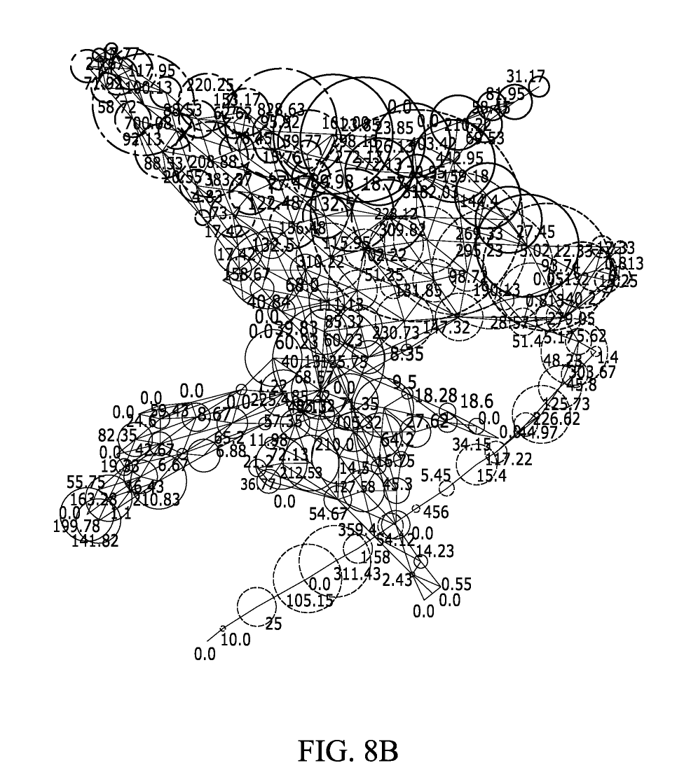

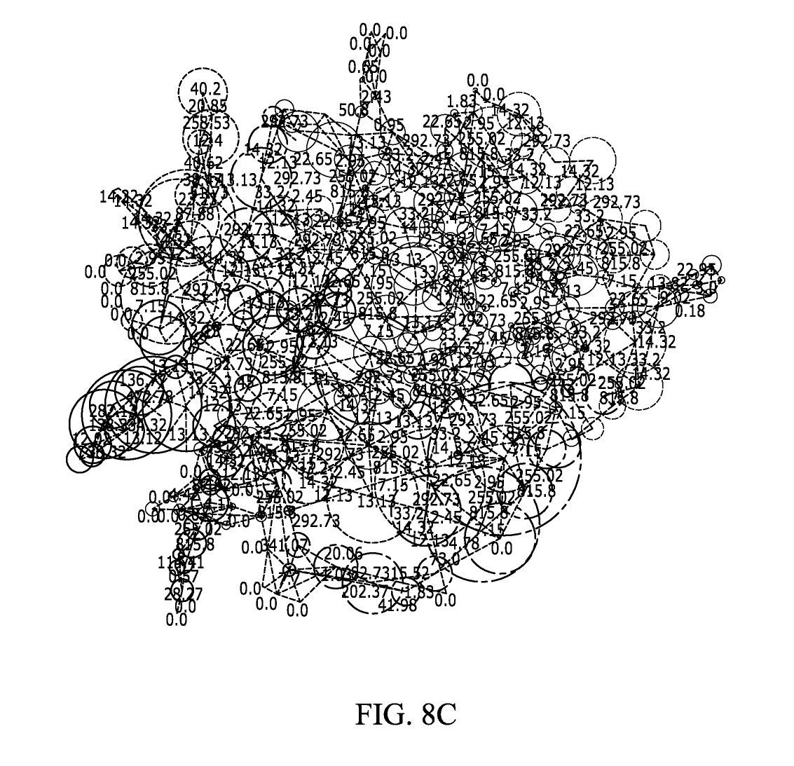

FIGS. 8A-8C illustrate example adjacency graphs generated based on the edge connectivity and the edge weights. FIG. 8A, for example, illustrates the adjacency graph corresponding to the division of the geographical area as shown in FIG. 6A. Because the region size parameter is larger in FIG. 6A (as compared to those of FIGS. 6B and 6C), the adjacency graph contains less and larger nodes. FIG. 8A corresponds to an 8-linkage adjacency graph. FIG. 8B, for example, illustrates the adjacency graph corresponding to the division of the geographical area as shown in FIG. 6B, and also corresponds to an 8-linkage adjacency graph. Finally, FIG. 8C illustrates the adjacency graph corresponding to the division of the geographical area as shown in FIG. 6C, and also corresponds to an 8-linkage adjacency graph. Since the region size for FIG. 6C was significantly smaller than that of, for example, FIG. 6A, the number of nodes in the adjacency graph of FIG. 8C is significantly higher than that of, for example, FIG. 8A.

Returning to FIG. 5, after the adjacency graph is generated at block 515, the electronic processor 105 repartitions the adjacency graph into the desired number of partitions (that is, the desired number of geographical service areas) at block 520. In other words, the electronic processor 105 generates a partition map based on the adjacency graph that is generated. The electronic processor 105 repartitions the adjacency graph such that the total sum of time allocated to incidents of different types for each partition corresponds to the desired workload distribution (or are similar to the desired workload distribution). The electronic processor 105 also generates the partitions while attempting to maintain the workload within the workload imbalance threshold.

The electronic processor 105 then calculates a compactness index and a workload distribution index for the generated partition map (block 525). The compactness index provides an objective and numerical measure that indicates how compact a particular geographical service area is. Typically, a compactness of a particular partition map is determined by dividing the perimeter of the geographical service area (or partition) over the area of the partition (sometimes referred to as the Schwarzberg Index). The electronic processor 105, however, considers not only the perimeter and the area of a partition, but also the length of a diagonal of a circumscribing shape (for example, a circumscribing rectangle or circle) for the partition. In particular, the electronic processor 105 determines the compactness index for each partition according to Equation 1 below, where P is the perimeter of the partition, S is the area of the partition, and D is the diagonal of the circumscribing shape:

$$Compactness Index = P \times \frac{D}{S} \qquad Equation 1$$

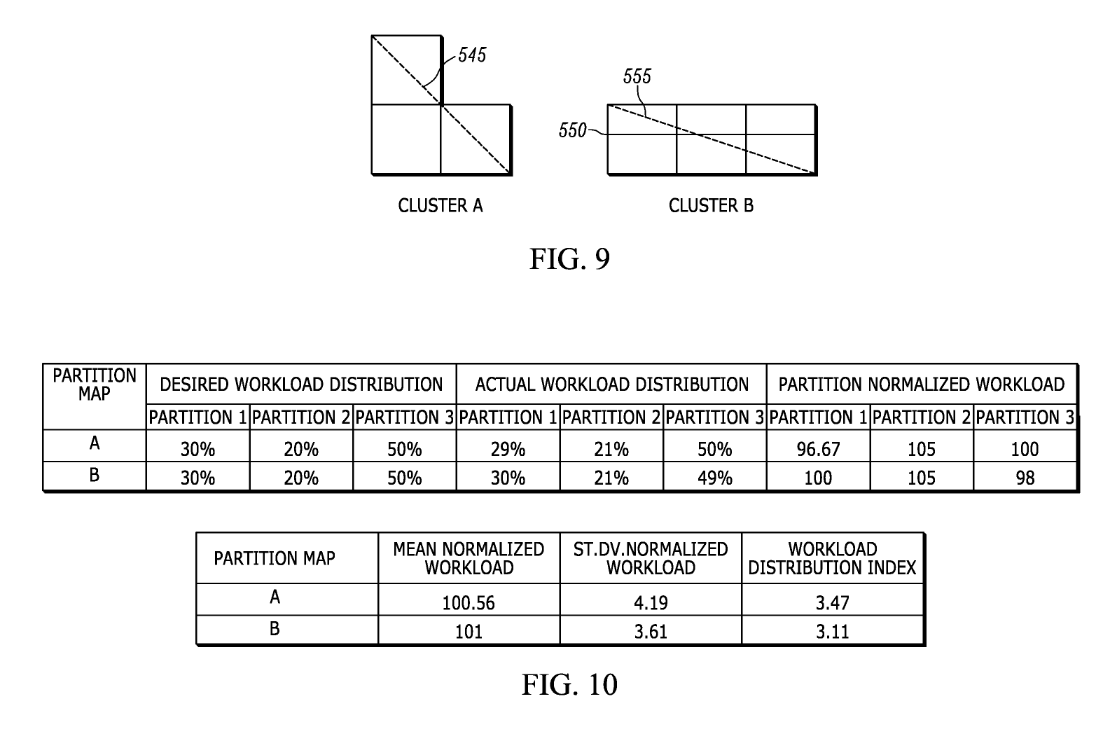

The compactness index calculated by the electronic processor 105 is superior to the index calculated using only the perimeter and the area because the compactness index can differentiate among a wider set of partitions that have the same area and perimeter but are nevertheless more compact. FIG. 9 illustrates two example partition areas (Cluster A and Cluster B). Both clusters (that is, partitions) have the same area and the same perimeter. Cluster A, however, is more compact than Cluster B. Intuitively, the compactness measure may be understood by determining which partition would make it easier to travel from one corner of the partition to the other. With respect to cluster A, the shortest distance between opposite corners is shown as diagonal line 545, which has a length of approximately 2.828 units (that is, two times the square root of two). With respect to cluster B, however, the shortest distance between opposite ends is shown as horizontal line 550, which has a length of three units. The diagonal of a circumscribing rectangle of cluster B would correspond to line 555, which has a length of approximately 3.16 units (that is, square root of ten). As shown in the illustrated example, the diagonal line 545 of cluster A is shorter than both the horizontal line 550 between opposite ends and the diagonal line 555 between opposite corners. Accordingly, cluster A is more compact than cluster B. The measure of the diagonal of a circumscribing shape for the partition takes into account the compactness of cluster A, whereas previous measures of compactness cannot differentiate between cluster A and cluster B.

To assign a compactness index to the partition map rather than to each partition, the electronic processor 105 calculates the average compactness index of the partition map. In one example, a partition map is divided into three partitions having a compactness index of 20.02, 13.17, and 12.65, respectively. The electronic processor 105 calculates the average of the compactness indices for the partition map to be 15.28, and assigns the average to be the compactness index associated with the partition map. In some embodiments, the maximum compactness index for a partition of the partition map is assigned as the compactness index associated with the partition map. In other embodiments, the minimum compactness index for a partition of the partition map is assigned as the compactness index associated with the partition map.

The electronic processor 105 also calculates a workload distribution index indicative of how well the actual workloads for the various partitions follow the desired workload distribution. To calculate the workload distribution index, the electronic processor 105 compares the actual workload (that is, the total time allocated to service calls) within each partition to the desired workload distribution for that particular partition. FIG. 10 illustrates a table with example measurements for two different partition maps: partition map A and partition map B. In the example shown in FIG. 10, the desired workload distribution indicates that the geographical area is to be divided into three partitions, and that 30% of the workload is to be handled by partition 1, 20% of the workload is to be handled by partition 2, and 50% of the workload is to be handled by partition 3. Based on the partition maps generated by the electronic processor 105 and the workload vectors associated with each region within each partition of the partition maps, the electronic processor 105 also calculates the actual workload for each partition. In the example of FIG. 10, for partition map A, the first partition handles 29% of the workload, the second partition handles 21% of the workload, and the third partition handles 50% of the workload. In contrast, for partition map B, the first partition handles 30% of the workload, the second partition handles 21% of the workload, and the third partition handles 49% of the workload. The electronic processor 105 uses the desired workload distribution and the actual workload distribution to calculate the partition normalized workload. In particular, the electronic processor 105 calculates the partition normalized workload (that is, τᵢ) according to Equation 2 below, where Tᵢ indicates the actual workload time for the i^{th} partition, αᵢ is the desired percentage of the workload distribution, and T is the total time (for example, among all the partitions) allocated to attending to service calls.

$${τ}_{i} = \frac{{T}_{i}}{{α}_{i} T} \times 100 \% , where T = {\sum }_{i = 1}^{n} {T}_{i} \qquad Equation 2$$

In the example shown in FIG. 10, the partition normalized workload for partition map A corresponds to 96.67 for partition 1, 105 for partition 2, and 100 for partition 3 after utilizing Equation 2 above. The partition normalized workload for partition map B corresponds to 100 for partition 1, 105 for partition 2, and 98 for partition 3. The mean of the partition normalized workload for the three partitions is calculated as well as the standard deviation. The mean of the normalized workload for partition A is 100.56 with a standard deviation of 4.19. Partition B, on the other hand, has a mean normalized workload of 101 with a standard deviation of 3.61.

The mean normalized workload and the standard deviation may, in some instances, be used to compare different partition maps. However, because two different measurements are used, it is hard to compare two different partition maps, especially when each partition map includes a more desirable value in only one of the measurements. For example, referring back to the example of FIG. 10, partition map A includes a mean normalized workload closer to 100 than the mean normalized workload of partition map B at 101. However, partition map A is associated with a higher standard deviation of 4.19 while the second partition map B is associated with a lower standard deviation of 3.61. In other words, selecting the partition that is more adequate becomes a matter of chance when each measure (that is, the mean and the standard deviation) point to a different partition. To alleviate this problem and make partition maps easier to compare, the electronic processor 105 calculates the workload index according to Equation 3 below, where n is the number of partitions and τᵢ is the normalized workload for each partition:

$$Workload Distribution Index = \sqrt{\frac{1}{n} {\sum }_{i = 1}^{n} {( {τ}_{i} - 100 )}^{2}} \qquad Equation 3$$

In particular, the workload distribution index calculates the deviation of the normalized workload for each partition (that is, τᵢ) from a constant value (that is, 100). By contrast, the standard deviation calculation calculates the difference between the normalized workload for each partition (τᵢ) and the mean of the normalized workload. In other words, the calculation of the standard deviation depends on the calculated mean normalized workload for the partition map, whereas the calculation of the workload distribution index uses a constant value (that is, 100) instead of the variable of the mean normalized workload. Calculating the workload distribution index using a constant value for all the partition maps, allows direct comparisons between different partition maps using a single value.

Referring back to FIG. 5, the electronic processor 105 then determines whether other values for the input parameters remain to be evaluated (block 530). When the electronic processor 105 determines that the different values for the partition parameters have not been exhausted yet, the electronic processor 105 changes a first value of one of the input parameters to a second value (block 535), and returns to block 505 to generate a different adjacency graph based on the new value (that is, the second value) of the input parameter. For example, the first adjacency graph may be based on the first values for the edge weight, buffer distance, region size, and edge connectivity parameters. The electronic processor 105 then changes the edge connectivity parameter to a second value to generate the second adjacency graph. The electronic processor 105 also generates other adjacency graphs that are based on the edge connectivity parameter having the second value, and changing other input parameters such as the buffer distance and/or the region size. In other words, by changing the parameter value, the electronic processor 105 generates a second plurality of partition maps to display on the chart 300 of FIG. 3. As described above, the input parameters include, for example, region size, buffer distance, graph connectivity, edge weights, and the like. In some embodiments, each input parameter has a specific number of values that are to be varied. For example, the region size parameter may be set to be varied between 1 km, 500 m, and 250 m, while the graph connectivity is only varied between 8-way linkage and 4-way linkage. The electronic processor 105 changes the values of the input parameters until all combinations of the input parameter values are used such that each combination of the input parameters generates an adjacency graph. In the example above, the electronic processor 105 generates a total of six adjacency graphs based on the different values for the region size and the graph connectivity parameters.

By generating a plurality of partition maps, each based on different input parameters, the electronic processor 105 increases the options for dividing the geographical area. In some embodiments, the electronic processor 105 receives an indication of the different values to be used for each of the input parameters. In other embodiments, the electronic processor 105 accesses from memory the different values to be used for each of the input parameters. In other words, the electronic processor 105 generates partition maps based on the same values of input parameters for different geographic areas (for example, districts, cities, counties, and the like). In yet other embodiments, the electronic processor 105 continues to vary the values of the input parameters until a certain number of partition maps are generated (for example, the electronic processor 105 generates 500 partition maps).

After the electronic processor 105 has generated the plurality of partition maps, the electronic processor 105 uses the display screen 120 to generate a display the plurality of partition maps on a chart as described with respect to block 230 of FIG. 2. In the example shown in FIG. 4, each partition map is represented on the chart 300 as a symbol and is positioned on the chart 300 according to its compactness index and its workload distribution index. Additionally, as discussed above with respect to the compactness and the workload distribution index, the partition maps that are expected to perform better when implemented are characterized by lower compactness and workload distribution indices. The symbols for the partition maps with lower compactness and lower workload distribution indices are displayed closer to the axes, and can be easily identified. Therefore, providing a chart 300 such as illustrated in FIG. 4, a user can easily identify which partition maps are expected to perform better during implementation. In some embodiments, the compactness and/or workload distribution indices vary significantly among the various partition maps. Accordingly, in some embodiments, one or more of the axes of the chart 300 may use a logarithmic scale to improve chart readability and have the ability to display partition maps (that is, symbols representing the partition maps) with greatly varying compactness and/or workload distribution indices in a more compact display.

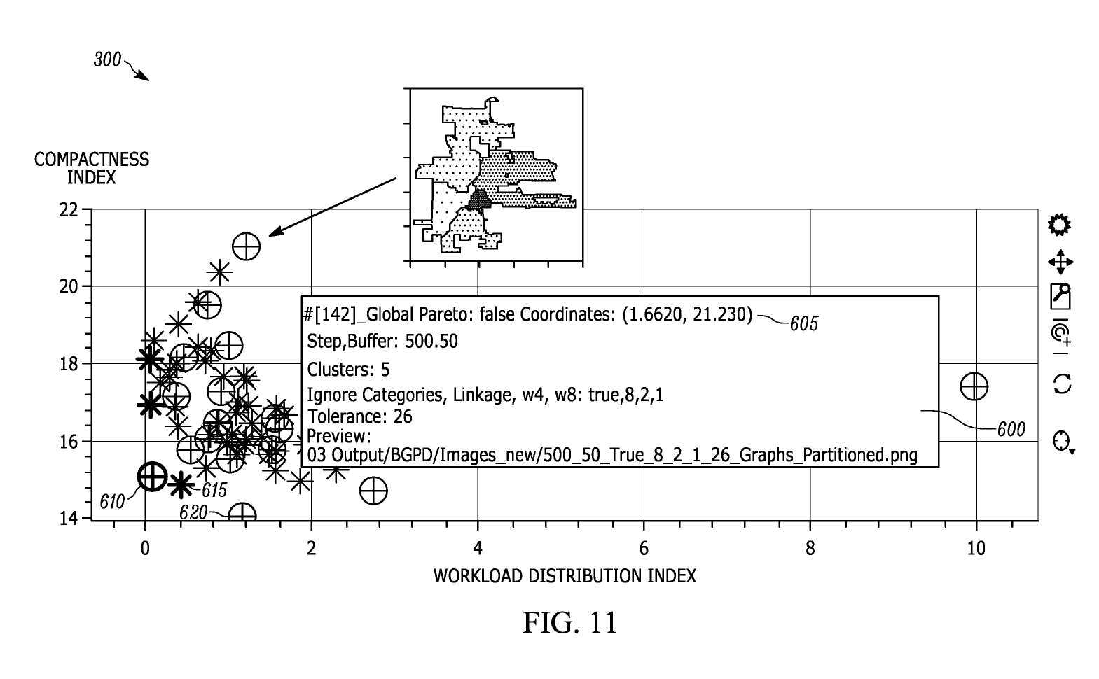

Additionally, as shown in FIG. 11, when a particular symbol is selected from the chart 300, additional details and information regarding the specific partition map is provided. For example, the electronic processor 105 may receive, from the input devices 125, a selection of a particular symbol on the chart 300. In response to receiving the selection of a symbol on the chart 300, the electronic processor 105 generates a graphical user interface that illustrates additional details such as, for example, statistical data, regarding the selected partition map. In the example of FIG. 11, when a symbol of the chart 300 is selected a pop-window 600 is displayed on the display screen 120. The pop-up window 600 indicates information regarding the selected partition map such as, for example, the coordinates corresponding to the workload distribution index and the compactness index 605, the values for the input parameters such as region size (that is “step” in FIG. 11), buffer distance, graph linkage, and the tolerance (for example, the workload distribution imbalance threshold). In the illustrated embodiment, selecting a symbol on the chart 300 also generates a graphical representation of the selected partition map (for example, a map interface or representation). To aid the user in selecting an adequate partition map, the electronic processor 105 also highlights those symbols representing the partition maps with the lowest workload distribution and compactness indices, as shown, for example, by symbols 610, 615 and 620 on FIG. 11. For example, the electronic processor 105 may highlight the partition maps with a workload distribution index below a workload distribution threshold and/or the partition maps with a compactness index below a compactness threshold. The workload distribution threshold and the compactness threshold may vary with each set of partition maps. For example, the workload distribution threshold and the compactness threshold may be determined to be a certain percentage above the lowest workload distribution index and the lowest compactness index, respectively. In other embodiments, the electronic processor 105 highlights, for example, five symbols corresponding to the partition maps with the lowest compactness indices and five symbols corresponding to the partition maps with the lowest workload distribution indices. In some embodiments, the electronic processor 105 highlights more or less symbols on the chart. The electronic processor 105 may highlight the symbols by, for example, changing the color of the symbols, using a fill color to highlight them, making the symbols bolder or larger in size, and the like.

While FIGS. 4 and 11 illustrate charting the partition maps based on their overall workload distribution index and their compactness index, the electronic processor 105, in some embodiments, generates charts of the partition maps based on their compactness index and the workload distribution index for specific work categories. That is, because the work vector for each region (or node) of the adjacency graph includes information regarding the time spent on resolving incident of each particular type, the workload distribution index can be made specific for particular incident types. For example, rather than analyzing the time spent in each region to resolve calls for service of all incident types, the electronic processor 105 determines the amount of time spent in each region resolving calls for service for incidents of type 1 (for example, robberies). Because the work vectors would be different, focusing on different incident types would allow the electronic processor 105 to generate different partition maps. For example, FIG. 12A graphically illustrates the different partition maps generated, by the electronic processor 105, when focusing on resolving calls for service for incidents of type 1. By contrast, FIG. 12B graphically illustrates the different partition maps generated, by the electronic processor 105, when focusing on resolving calls for service for incidents of type 2. The public service agency may choose a partition map based on the overall workload distribution index, or based on the workload distribution index for certain incident types or categories.

Additionally, due to the versatility of the work vector for each region of the adjacency graph, other factors may be considered and/or isolated when generating the partition maps. For example, the time allocated to resolve the call for service may, in some embodiments, include travel time to reach the location of the call for service. The work vector may also be separated based on the times that the calls for service were received and/or resolved such that a workload vector may be generated for each of the regions of the adjacency graphs based on different work shifts or times of day. The electronic processor 105 may then be able to determine a plurality of partition maps for a particular shift. The electronic processor 105 may also incorporate other factors into the work vector for each region of the adjacency graph such as, for example, census data.

FIG. 13 illustrates a table comparing two different partition maps. The partition map represented by the top table refers to a current partition map, while the partition map represented by the lower table refers to a partition map generated via the geographical service area determination system 100. In the example shown in FIG. 13, the current partition map has a compactness index of 20.183 and a workload distribution index of 49.81. By contrast, the suggested partition by the geographical service area determination system has a compactness index of 13.76 and a workload distribution index of 0.59. In other words, based on a direct comparison between two different partition maps, it is clear that the partition map suggested by the system 100 is superior to the current partition map. In other words, the partition map suggested by the system 100 has geographical service areas (that is, partitions) that are more compact than the geographical service areas of the current partition map. The workload is also better distributed in the suggested partition map than the current partition map.

In some embodiments, the electronic processor 105 also calculates a stability index for each partition map. The stability index measures how well the workload distribution for a particular partition map is expected to perform for an extended period of time. In other words, the stability index indicates how likely it is for the workload distribution associated with a partition map will remain relatively constant for extended periods such as, for example one year. To assess the stability of the workload distribution and balance for the partition maps, the incident data is used to determine the stability workload vectors for each of the regions of the adjacency graph. In contrast to what was described with respect to block 510 above, however, the incident data and the stability workload vectors also specify a particular yearly quarter during which the time was allocated to resolve the calls for service. For example, a workload vector without dividing based on which yearly quarter the call for service was resolved may include the following vector, where i represents the type of incident:

$$T = [ \begin{matrix}{t}_{1} \\ {t}_{2} \\ … \\ {t}_{i}\end{matrix} ]$$

When the workload is divided based on the yearly quarter during which the incident was resolved, the workload vector for each region can be represented as shown below, where each column represents a yearly quarter. The example shown below illustrates the workload vector including incident data for four quarters (that is, a year).

$$T = [ \begin{matrix}{t}_{11} {t}_{12} {t}_{13} {t}_{14} \\ {t}_{21} {t}_{22} {t}_{23} {t}_{24} \\ … \\ {t}_{i 1} {t}_{i 2} {t}_{i 3} {t}_{i 4}\end{matrix} ]$$

By dividing the workload vector by the yearly quarter in which the time was allocated to the incident, the electronic processor 105 can then determine what the workload distribution index would be for each quarter for a particular partition map. Based on the variability of the workload distribution index between previous quarters, the electronic processor 105 determines a measure of how well the workload distribution index is expected to perform in future yearly quarters. For example, when the electronic processor 105 determines that a particular partition map has a good workload distribution index when the workload is not divided by yearly quarter, but has a high variability (for example, a high standard deviation) when the workload is divided by the yearly quarter, the electronic processor 105 assigns a higher stability index. That is, a higher stability index indicates high variability of the workload distribution over time, while a lower stability index indicates lower variability of the workload distribution over time. In some embodiments, the electronic processor 105 divides the workload data based on a different time period instead of yearly quarters. For example, the electronic processor 105 divides the workload data based on which month the time was allocated to particular incidents or calls for service.

The stability index can be added as a third axis on the chart such that the symbols representing the different partition maps may also be graphed according to their stability index. Other ways of representing which partition maps are associated with lower stability indices may be used. For example, the electronic processor 105 may highlight just the symbols or partition maps with the lowest, for example, 10 stability indices. In some embodiments, the electronic processor 105 may use a color scheme to represent which partition maps have higher or lower stability indices. In yet other embodiments, a slider may be generated as part of the graphical user interface. The position of the slider may correspond to different values or ranges for the stability index. The chart showing the symbols based on the compactness index and the workload distribution index would then change to show the partition maps that are associated with a stability index within the range indicated by the position of the slider. In other embodiments, however, the electronic processor 105 may chart the partition maps based on only the compactness index and the workload distribution index, but provide the stability index when a particular symbol for a partition map is selected.

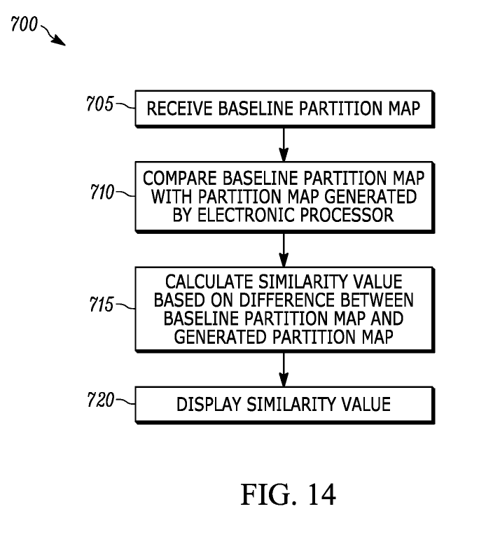

In some embodiments, the electronic processor 105 also executes a method 700 of determining a similarity value, as shown in FIG. 14. In such embodiments, the electronic processor 105 receives a baseline partition map (block 705). The baseline partition map refers to, for example, a current partition map (or a suggested partition map). In some embodiments, the electronic processor 105 receives the baseline partition map as part of the map information from the map database 135. In other embodiments, the electronic processor 105 receives a separate data file indicating the geographical boundaries of the baseline partition map. The electronic processor 105 then compares the baseline partition map with a partition map generated by the electronic processor 105 as described by FIG. 5 (block 710). In other words, after generating a partition map based on the incident data, the map data, and the input parameters, the electronic processor 105 compares the generated partition map with the baseline partition map. In particular, the electronic processor 105 compares the geographical boundaries of each partition between the generated map and the baseline partition map. The electronic processor 105 then calculates a similarity value based on, for example, the difference in geographical boundaries of the generated partition map and the baseline partition map (block 715). The electronic processor 105 then displays the similarity value (block 720). In some embodiments, the similarity value may be displayed as part of the statistical data displayed in response to receiving a selection of a partition map as discussed with respect to FIG. 11. In particular, the similarity value increases as the difference between the generated partition map and the baseline partition map decreases. Thereby, a high similarity value indicates that the generated map strongly resembles the baseline partition map.

Public service agencies typically prefer not to change partition maps too drastically because, for example, workers may get confused on which areas they are to patrol. Calculating and displaying the similarity value allows the users (for example, supervisors) to determine an adequate partition map that balances the workload for the geographical area, but also resembles the baseline partition map so as to minimize the changes to each partition. In some embodiments, the electronic processor 105 may generate a chart in which one of the axes corresponds to the similarity value. Additionally or alternatively, the electronic processor 105 may generate a list of the possible partition maps in which the partition maps are displayed according to the workload distribution index, the compactness index, the stability index, and/or the similarity value.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized electronic processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (for example, comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of determining geographic service areas, the method comprising:
receiving, at an electronic processor, map information corresponding to a geographical area;
receiving, at the electronic processor, incident information corresponding to the geographical area;
generating, with the electronic processor, a plurality of partition maps of the geographical area based on the map information and the incident information, each partition map including one or more partitions, each of the one or more partitions representing a geographical service area; and
displaying, with the electronic processor, the plurality of partition maps as symbols on a chart according to a compactness index and a workload distribution index of each partition map.

2. The method of claim 1, wherein generating the plurality of partition maps includes generating the plurality of partition maps based on a parameter having a first value, the method further comprising:
changing the first value of the parameter to a second value;
generating, with the electronic processor, a second plurality of partition maps based on the second value, the map information, and the incident information; and
displaying the second plurality of partition maps on the chart according to the compactness index and the workload distribution index of each partition map.

3. The method of claim 1, wherein generating the plurality of partition maps includes generating the plurality of partition maps based on a buffer distance indicating a distance extending from a perimeter of the geographical area.

4. The method of claim 1, wherein generating the plurality of partition maps includes generating the plurality of partition maps based on an edge connectivity parameter indicating a linkage structure between nodes of an adjacency graph corresponding to the geographical area.

5. The method of claim 1, wherein generating the plurality of partition maps includes:
dividing, with the electronic processor, the geographical area into a plurality of regions;
generating an adjacency graph in which each of the plurality of regions corresponds to a node, and wherein a first node and a second node are connected with an edge;
assigning an edge weight to the edge; and
generating the plurality of partition maps based on the edge weight.

6. The method of claim 1, further comprising:
calculating a diagonal of a circumscribing shape for each partition within each partition map; and
calculating the compactness index for each partition map based on the diagonal of the circumscribing shape for each partition of the partition map.

7. The method of claim 1, further comprising:
calculating, with the electronic processor, a normalized workload for each partition based on a target workload for the geographical service area;
calculating a difference between the normalized workload for each partition and a constant value; and
calculating, with the electronic processor, the workload distribution index based on the difference of the normalized workload for each partition and the constant value.

8. The method of claim 1, further comprising,
receiving, at the electronic processor, a selection of a symbol corresponding to a partition map; and
displaying one selected from a group consisting of statistical data for the partition map in response to receiving the selection, and a graphical representation of the partition map in response to receiving the selection.

9. The method of claim 1, further comprising, highlighting the symbols corresponding to partition maps having one selected from a group consisting of the compactness index being below a compactness threshold, and the workload distribution index below a workload distribution threshold.

10. The method of claim 1, further comprising, calculating, with the electronic processor, a similarity value for each partition map, the similarity value being based on a difference between the partition map and a baseline partition map.

11. The method of claim 1, further comprising, selecting a partition map from the plurality of partition maps, and transmitting, with the electronic processor, the partition map to a plurality of electronic devices.

12. A service area determination system comprising:
a memory storing non-transitory instructions;
an electronic processor coupled to the memory and configured to extract instructions from the memory, and execute the instructions to:
receive map information corresponding to a geographical area,
receive incident information corresponding to the geographical area, and
generate a partition map of the geographical area based on the map information and the incident information, the partition map including one or more partitions, each of the one or more partitions representing a geographical service area; and
a display screen coupled to the electronic processor and configured to display the partition map as a symbol on a chart according to a compactness index and a workload distribution index of the partition map.

13. The system of claim 12, wherein the electronic processor is configured to
generate the partition map based on a parameter having a first value,
change the first value of the parameter to a second value,
generate a second partition map based on the second value of the parameter, the map information, and the incident information, and
display the second partition map on the chart according to the compactness index and the workload distribution index for the second partition map.

14. The system of claim 13, wherein the electronic processor generates the partition map based on one selected from a group consisting of an edge connectivity parameter and a buffer distance, the edge connectivity parameter indicating a linkage structure between nodes of an adjacency graph corresponding to the geographical area, and the buffer distance indicating a distance extending from a perimeter of the geographical area.

15. The system of claim 13, wherein the electronic processor is configured to divide the geographical area into a plurality of regions,
generate an adjacency graph in which each of the plurality of regions corresponds to a node, and wherein a first node and a second node are connected with an edge,
assign an edge weight to the edge, and
generate the partition map based on the edge weight.

16. The system of claim 13, wherein the electronic processor is configured to
calculate a diagonal of a circumscribing shape for each partition within the partition map, and
calculate the compactness index for the partition map based on the diagonal of the circumscribing shape for each partition of the partition map.

17. The system of claim 13, wherein the electronic processor is configured to
calculate a normalized workload for each partition of the partition map based on a target workload for the geographical service area,
calculate a difference between the normalized workload for each partition and a constant value, and
calculate the workload distribution index based on the difference between the normalized workload for each partition and the constant value.

18. The system of claim 13, wherein the electronic processor is configured to
receive a selection of the symbol corresponding to the partition map,
control the display screen to display statistical data for the partition map in response to receiving the selection, and
control the display screen to display a graphical representation of the partition map in response to receiving the selection.

19. The system of claim 13, wherein the display screen is configured to display the symbol according to the compactness index, the workload distribution index, and a stability index for the partition map.

20. The system of claim 13, wherein the electronic processor is configured to calculate a similarity value for the partition map, the similarity value being based on a difference between the partition map and a baseline partition map.
